(19) United States
(12) Patent Application Publication
(10) Pub. No.: US 2021/0046908 A1
(43) Pub. Date: Feb. 18, 2021

(54) Wheel Motion-Restraining Devices and Methods

(71) Applicants: Taryn Omran, Denver, CO (US); Shai Omran, Denver, CO (US)

(72) Inventors: Taryn Omran, Denver, CO (US); Shai Omran, Denver, CO (US)

(21) Appl. No.: 16/993,580

(22) Filed: Aug. 14, 2020

Related U.S. Application Data
(60) Provisional application No. 62/922,563, filed on Aug. 15, 2019.

(51) Int. Cl. B60T 3/00

(52) U.S. Cl. CPC B60T 3/00

(57) ABSTRACT

Wheel motion-restraining devices disclosed herein stabilize wheeled vehicles, such as shopping carts, to increase safety and loading/unloading convenience and to decrease the chance for property and personal damage from runaway carts. The devices are inexpensive, easy to use, and convenient to store.

### CROSS-REFERENCE TO RELATED APPLICATIONS

This application claims the benefit of and priority to U.S. Provisional Patent Appl. No. 62/922,563, filed Aug. 15, 2019, which is hereby incorporated by reference in its entirety.

### BACKGROUND

Today, in most large grocery stores, markets, and other retail and wholesale establishments, shopping carts are provided for the convenience of customers. The carts typically have multiple wheels to allow the customer to push or pull the cart easily around the store. There is also usually a place for one or more small children to ride in the cart. Not only do such carts provide for convenient shopping within stores and markets, they are also commonly employed by customers or store employees in adjacent parking lots.

Trolleys and wagons of varying types are also employed by many types of business establishments when moving merchandise from one physical location to another. Examples of businesses that employ carts for many different purposes, include, but are not limited to hotels, airlines, libraries, record centers, donation sites, garment wholesalers and kitchens.

The terrain that these carts, trolleys and wagons encounter is often uneven or sloping, sometimes by design to enable self-drainage after rain or snow. The carts, being designed for easy wheeling, tend to roll by themselves over such sloping areas, especially in windy conditions. The unexpected rolling of carts during unloading or loading presents a safety hazard to children in the cart and people walking nearby, as well as a property hazard to automobiles and other nearby infrastructure.

In an attempt to avoid such accidents, some stores provide their customers with shopping carts that have built in wheel-braking systems, but because of the extra cost of these shopping carts, not many stores make this investment. Additionally, there is a product on the international market that is adhered to the ground at the end of each parking spot in a parking lot. There are also shopping carts that will only move if a lever in the handlebar is pressed. However, these products must be purchased and installed by the store—again a costly investment for the store and therefore an uncommonly seen product. Another product on the market, also designed to stop a shopping cart from rolling when unloading and loading, requires one to use a suction cup on the body of their auto and connect the other end to the shopping cart. This product is flawed in that the user is limited in where they can place the cart in relation to their auto while unloading and the suction could dent the body of the auto. Another solution is an oversized shovel-type product that one steps on when rolling the wheel on top. However, the handle and the part that rests under the wheel are in line with each other, which can result in scraped knuckles from picking up the product after use, and the product is made of hard plastic that results in sliding on smooth surfaces, defeating the purpose of the product. Finally, there is a product that allows a shopper to carry a small zippered bag on their keychain that contains two small rounded cylinders the size of stones. The shopper positions the cylinders in front of the wheels of the shopping cart when unloading to prevent the wheels from moving. This requires one to touch the ground and the shopping cart wheel. Further, the user must carry the product around on their keychain or risk misplacing it because the container is so small. Additionally, this solution is not suitable for use by everyone. For instance, people with arthritis in the hands would find the small device and container difficult to use.

The products discussed above fail to meet the needs of the market because they are either expensive—designed for purchase by the store rather than the customer—or they are designed to be purchased by the customer, yet have major design flaws. With the problem of runaway carts not being solved by the products mentioned above, there is still a need for an economical, effective solution.

### SUMMARY

Wheel motion-restraining devices disclosed herein are conveniently stored and used with minimal fuss and without exposing the users' hands to dirt, germs or risk of scrapes. The devices are available in a variety of shapes, sizes and looks, but generally comprise a body having a substantially flat bottom surface, a raised top surface and a central depression. A handle and a magnetized bottom surface are optional additional features.

In an aspect, a motion-restraining device comprises a body having a substantially flat bottom surface, a raised top surface, and a central depression, wherein the raised top surface is higher on one side of the central depression than on the other side of the central depression.

In an embodiment, a raised top surface is formed by two substantially planar surfaces that meet between edges of the substantially flat bottom surface to form a peak. Generally, an incline and/or decline of the raised top surface may improve stability and help a wheel come to a full stop within a central depression of the body.

In an embodiment, a body is substantially circular, substantially square, substantially triangular, substantially pentagonal or substantially hexagonal in shape. In an embodiment, a body has a substantially triangular cross section, a substantially rectangular cross section or a substantially trapezoidal cross section. In an embodiment, a body is a monolithic body. In an embodiment, a body is a cylinder cut on the bias.

In an embodiment, a central depression is open or partially filled with material of the body or completely filled with material of the body. For example, the body may have a void in the center where a wheel will sit touching the ground, or the body may not have a void in the center or may only have a partial void or partial voids in the center, where the wheel sits at a lower height than the outer edges of the body that maintain the wheel's stationary position.

In an embodiment, a motion-restraining device is formed of a material selected from the group consisting of plastic (e.g., PVC), rubber, silicone, wood, metal, carbon fiber, rope, wire and combinations thereof. In an embodiment, a motion-restraining device is made of a durable, non-porous material for ease of cleaning.

In an embodiment, an outer diameter of a body is between 3 inches and 12 inches, or between 3 inches and 10 inches, or between 3 inches and 8 inches, or between 4 inches and 7 inches, or between 4 inches and 6 inches. In an embodiment, an inner diameter of a body is between 1 inch and 10 inches, or between 1.5 inches and 8 inches, or between 2 inches and 6 inches, or between 2 inches and 4 inches. In an embodiment, a height of a body is between 0.5 inches and 3 inches, or between 0.5 inches and 2 inches, or between 0.5 inches and 1 inches, or between 0.5 inches and 0.8 inches. In an embodiment, a ratio of the highest point to the lowest point of the body is 3:1, or 2:1, or 8:5, or 6:5.

In an embodiment, a motion-restraining device further comprises one or more magnets on or within the substantially flat bottom surface.

In an embodiment, a motion-restraining device further comprises a handle affixed to the body. For example, a handle may be affixed to an outer wall of the body, e.g., at a height between the bottom surface and the top surface. In an embodiment, a handle is biased away from the substantially flat bottom surface to avoid contact with the ground when the motion-restraining device is placed on the ground. For example, the handle may be permanently biased away from the substantially flat bottom surface. In an embodiment, the handle is also biased away from the body. The handle may or may not be manufactured from the same material as the remainder of the restraining device. The handle may also comprise a spring clip, a re-closable fastener, or another mechanism that enables one to attach the device to a cart or personal item when not in use. In an embodiment, a motion-restraining device comprises multiple handles by which one may hold or hang the device. The handle(s) may be located anywhere on the device including but not limited to the top, the side or protruding from the bottom. Further, the handle(s) may take any type of shape, including but not limited to rounded, solid, hollow, pointed, flat, textured, large or small.

In an embodiment, a motion-restraining device further comprises a slot within the body. For example, the slot may extend completely or partially through a height of the body. In other words, the slot may form a break or gap within the body by extending full depth through the body. In another variation, the slot may form a ramp that extends a partial depth through the body. The slot is intended to allow a wheel to easily roll into the central depression without a user having to lift the wheeled vehicle. In an embodiment, a slot may have a different texture or color to differentiate the entry/exit point for the wheel.

In an embodiment, a slot may comprise a movable portion, such as a spring-loaded section that lowers when a wheel goes over it and then springs back to a higher position when the wheel has passed over, or the moveable portion may be foam that compresses when the weight of the wheel is on ft and then re-expands when the weight is released, or the moveable portion may be a drawbridge section that can be opened to allow the wheel to move into position and then closed behind the wheel to prevent movement.

In an embodiment, a substantially flat bottom surface and/or a raised top surface of a body is textured to improve grip and/or to add design features. For example, wheel restraining devices can be produced in various designs, shapes and colors/patterns for mass appeal including but not limited to tires, donuts, bagels, peace signs, life-saving rings, rubber ducks and other items.

In an aspect, a method of using a motion-restraining device comprises providing a motion-restraining device as described herein and positioning a wheel within a central depression of the motion-restraining device. For example, the wheel may be the wheel of a shopping cart, a wagon, a flat cart, a utility cart, a tricycle, a bicycle, a car, a golf cart, a boat trailer, a hand truck, a food cart, a rolling table, or any other object with one or more wheels.

In an embodiment, the step of positioning the wheel comprises rolling the wheel through a slot within a wall of the body of the device. In an embodiment, the step of providing a motion-restraining device comprises placing the motion-restraining device on the ground in front of one of the wheels of a wheeled vehicle.

In an embodiment, the step of providing comprises removing the motion-restraining device from a magnetic surface, such as a metal surface on or within an automobile. In an embodiment, the step of providing comprises using a handle of the motion-restraining device to remove the device from a magnetic surface.

In an embodiment, a method of using a motion-restraining device further comprises removing a wheel from a central depression of the device and moving the motion-restraining device to a storage position. In an embodiment, the step of removing the wheel comprises rolling the wheel through a slot within a wall of the body of the device. In an embodiment, moving the motion-restraining device to a storage position comprises attaching the device to a metal panel of an automobile and/or moving the device to an interior of a vehicle.

In an embodiment, a motion-restraining device may comprise words or symbols, such as arrows, to denote where a wheel is intended to enter or exit a central depression or for other purposes, such as branding.

In an embodiment, a motion-restraining device may be manufactured to couple with a holder, such as a wall-mounted holder.

In an embodiment, a motion-restraining device may have the same height and angles all around the body without one clear entrance/exit location so the wheel can enter/exit at any point.

In an embodiment, a motion-restraining device comprises one or more reflectors or is at least partially made of reflective material.

In an embodiment, a motion-restraining device comprises two or more wheel restraining devices connected to or joinable with one another, thereby enabling a user to restrain more than one wheel simultaneously.

Motion-restraining devices disclosed herein may be manufactured by additive manufacturing, subtractive manufacturing, computer numerical control (CNC) machining, injection molding, blow molding, laser etching, die casting and other known methods. All components may be made from one mold or multiple components may be connected after fabrication.

Motion-restraining devices disclosed herein may be manufactured in various shapes, heights, diameters, thicknesses, weights, colors, patterns, textures, designs, sizes, contours, materials and levels of translucency/transparency, for example.

### BRIEF DESCRIPTION OF THE DRAWINGS

Illustrative embodiments of the present invention are described in detail below with reference to the attached drawings, which may not be drawn to scale.

FIG. 1 shows a motion-restraining device in use with a shopping cart wheel, according to an embodiment.

FIG. 2 shows a top perspective view of a motion-restraining device, according to an embodiment.

FIG. 3 shows a top plan view of a motion-restraining device, according to an embodiment.

FIG. 4 shows a bottom plan view of a motion-restraining device, according to an embodiment.

FIG. 5 shows a motion-restraining device stored in the back of an automobile when not in use, according to an embodiment.

FIG. 6 shows additional embodiments of motion-restraining devices having different body shapes, profile shapes, and slot shapes, according to multiple embodiments.

FIG. 7 shows examples of additional embodiments of motion-restraining devices having different handle shapes, according to multiple embodiments.

FIG. 8 shows additional embodiments of motion-restraining devices having different body shapes, slot shapes, and handle shapes, according to multiple embodiments.

FIG. 9 shows a motion-restraining device being lifted by a handle, according to an embodiment.

FIG. 10 is a top perspective view of a wheel motion-restraining device, according to an embodiment.

FIG. 11 is a front plan view of the device of FIG. 10.

FIG. 12 is a back plan view of the device of FIG. 10.

FIG. 13 is a right side view of the device of FIG. 10.

FIG. 14 is a left side view of the device of FIG. 10.

FIG. 15 is a top plan view of the device of FIG. 10.

FIG. 16 is a bottom plan view of the device of FIG. 10.

### DETAILED DESCRIPTION

In general, the terms and phrases used herein have their art-recognized meaning, which can be found by reference to standard texts, journal references and contexts known to those skilled in the art. The following definitions are provided to clarify their specific use in the context of this description.

A “device” is a combination of components operably connected to produce one or more desired functions.

A “component” is used broadly to refer to an individual part of a device.

The terms “direct and indirect” describe the actions or physical positions of one component or object relative to another component or object. For example, a component or object that “directly” acts upon or touches another component or object does so without intervention from an intermediary. Contrarily, a component or object that “indirectly” acts upon or touches another component or object does so through an intermediary (e.g., a third component).

“Proximal” and “distal” refer to the relative positions of two or more objects, planes or surfaces. For example, an object that is close in space to a reference point relative to the position of another object is considered proximal to the reference point, whereas an object that is further away in space from a reference point relative to the position of another object is considered distal to the reference point.

“Monolithic” refers to materials or components that are touching or connected throughout in an unbroken sequence or formed as a single unit.

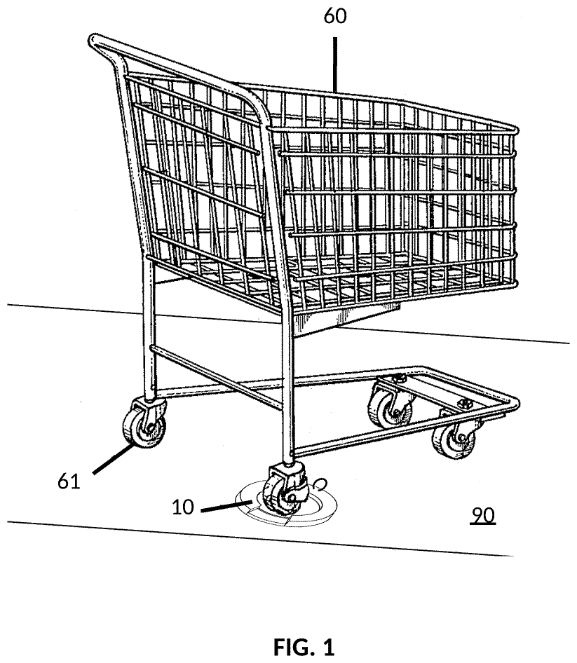

FIG. 1 shows a motion-restraining device 10 in use with a shopping cart wheel 61. For example, one may arrive at their vehicle 70 with their shopping cart 60, remove the wheel restraining device 10 from where it is magnetized to the outside of the trunk 71, or open the trunk and remove the device 10 from where it is being stored in the trunk 71 when not in use. By holding the tab/loop/handle 50 one can place the device on the ground 90, positioning it with an open entrance/exit section or slot 20, if one is provided, on the ground 90 in front of the wheel 61. Typically, the main body 30 would be positioned on the part of the ground with lower elevation to best prevent the wheel 61 from rolling. When one is done using the device 10, the user 80 can lift the device 10 by its handle/tab/loop 50 again and return it to the outside or inside of trunk 71 of their vehicle 70 for storage.

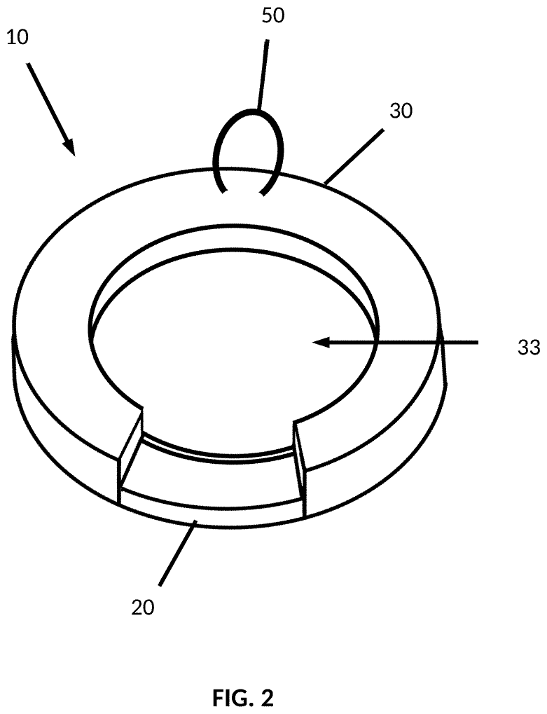

FIG. 2 shows a top perspective view of a motion-restraining device 10, according to an embodiment. As shown, there is a slot 20 that has a lower height to enable a wheel 61 to easily roll slightly up and over the slot into a central depression 33 of the device 10 without having to lift a potentially heavy wheeled vehicle, such as shopping cart 60. The main body 30 of device 10 comprises a raised top portion to prevent wheel 61 from rolling out of the device. The loop/handle/tab 50 may be placed on the top or side of device 10. This positioning allows the user 80 to pick up, move and place the device 10 without having to touch the main body 30 or the ground 90 which may be dirty, and which could lead to knuckle scraping. As shown, central depression 33 is a void where there is direct access from the wheel 61 to the ground 90. However, in other embodiments, central depression 33 may comprise a piece of material that fills or partially fills the depression such that wheel 61 may not touch the ground. Depending on the size of the wheel 61, it may or may not rest partially on the body 30 of the device 10.

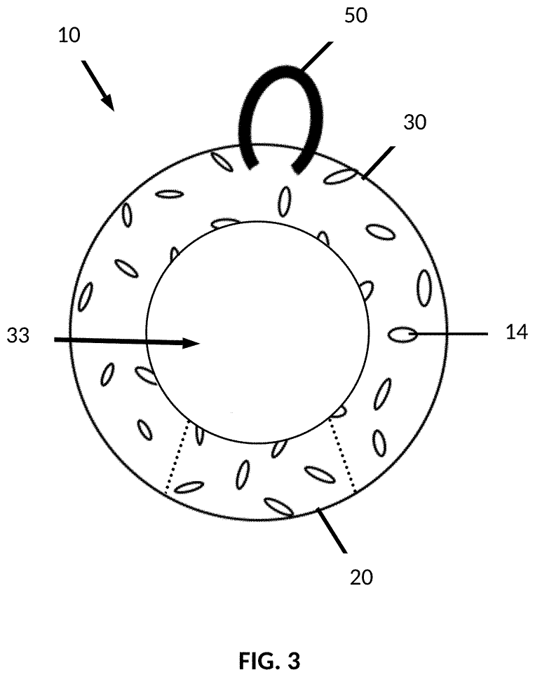

FIG. 3 shows a top view of a device 10, which is similar to that shown in FIG. 2, except that the device of FIG. 3 is made to look like a donut with sprinkles 14.

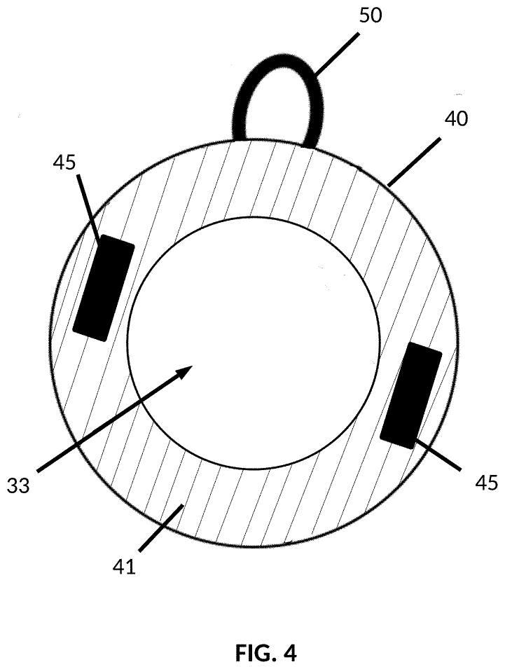

FIG. 4 shows a bottom view of a wheel motion-restraining device 10. From this view, one can see that a bottom surface 40 has one or more magnets 45 contained within the bottom 40 or applied to the base of the device to enable it to be adhered to other surfaces, such as metal pieces in the trunk 71 of one's vehicle 70 for convenient storage and ease of locating. Magnets 45 are shown as rectangles, but they may be formed in various shapes, sizes and materials. Additionally, bottom surface 40 may be textured and/or made of a compliant material to provide a non-slip surface.

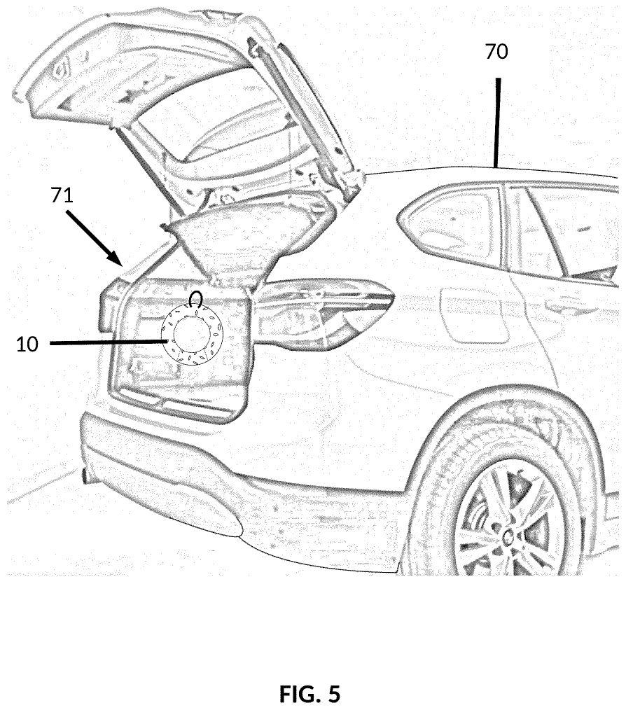

FIG. 5 shows a wheel motion-restraining device 10 stored in the back of an automobile 70 when not in use. For example, device 10 may be adhered to the inside of an automobile's trunk, perhaps on a wheel hub made of metal or hung by the tab/loop/handle 50 on a hook inside the back of the vehicle 70.

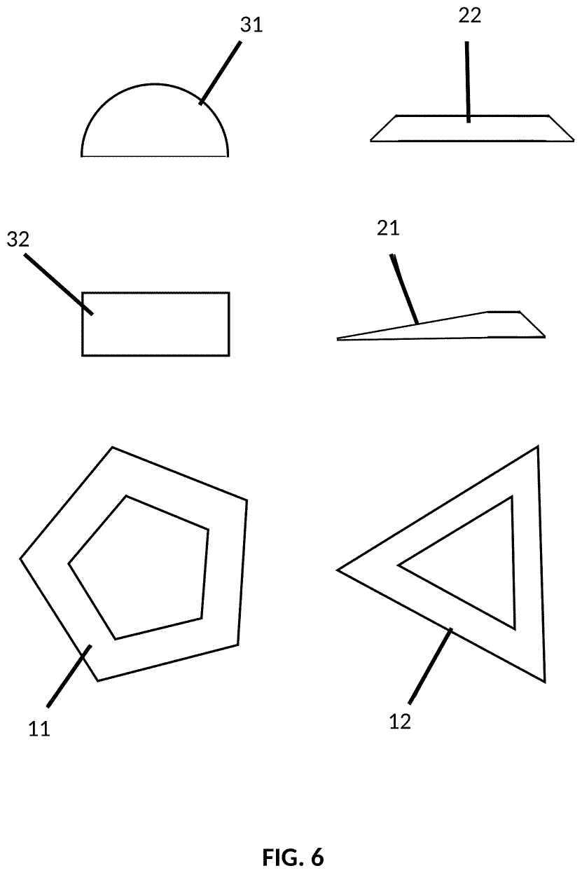

FIG. 6 shows examples of alternative embodiments of wheel motion-restraining devices 10 that have different main body 30 and/or slot 20 structures. For example, main body 30 may take the structure of a rounded shape with a flat bottom 31 or a rectangular shape 32. Similarly, slot 20 may take the form of a trapezoid 22 or another quadrilateral shape 21. The overall shape of device 10 may take many forms including but not limited to a hexagonal shape 11 or triangular shape 12 as alternatives to the ring shape displayed in other figures.

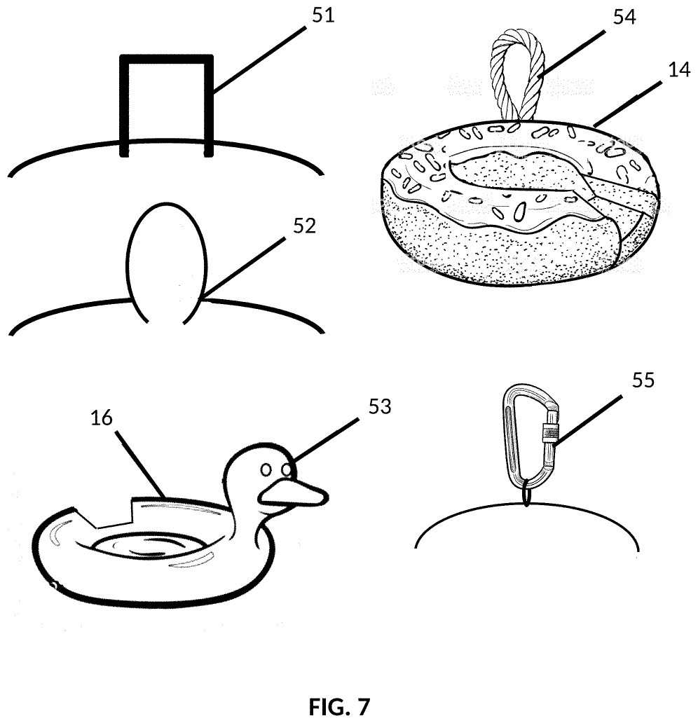

FIG. 7 shows examples of alternative embodiments where the device 10 and/or the loop/tab/handle 50 take different forms. For example, a loop/tab/handle 50 may be rectangular 51, a solid tab 52, a rope loop 45, a spring hook or a carabiner 55. An inflatable rubber duck design 16 uses a duck head 53 as the handle 50. In another embodiment, device 10 is designed to look like a donut with sprinkles 14.

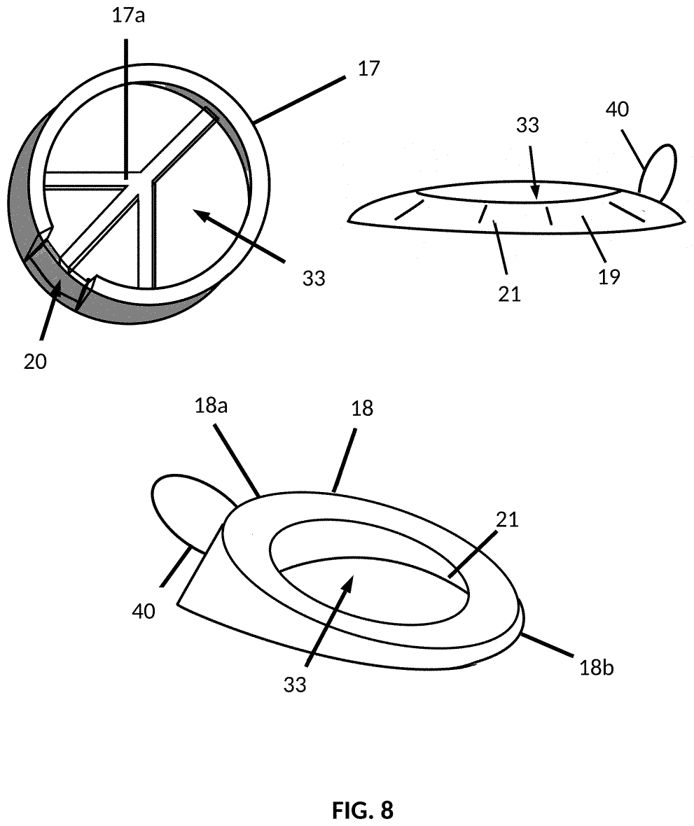

FIG. 8 shows examples of alternative designs such as a peace sign 17 that does not have an open void in central depression 33, but rather has a peace sign symbol 17a on top of which a wheel would come to rest when in use. This embodiment has a slot 20 and a higher/taller remaining edge designed to stop wheel 61 from further movement. Another design is a cylinder cut on the bias 18 where there is a higher/taller end 18a and a lower/shorter end 18b. Using this design one would roll a wheel over the lower end 18b and the wheel would come to rest in the center 33 of the device 10, blocked from further rolling by the higher end 18a of the wheel motion-restraining device. In this example, the outer edge and the inner edge are sloping 21 (i.e., non-perpendicular with respect to the ground) to provide a more stable base for the device 10. Another design is a modified saucer 19 with a gradual slope 21 on the outer and inner sides and a peak with a consistent height. In this embodiment, there is no clearly defined entrance/exit slot 20. The modified saucer embodiment allows the wheel 61 to enter/exit at any point around the circumference to come to rest in a central depression 33. As shown, the modified saucer 19 comprises a loop 40 that facilitates handling.

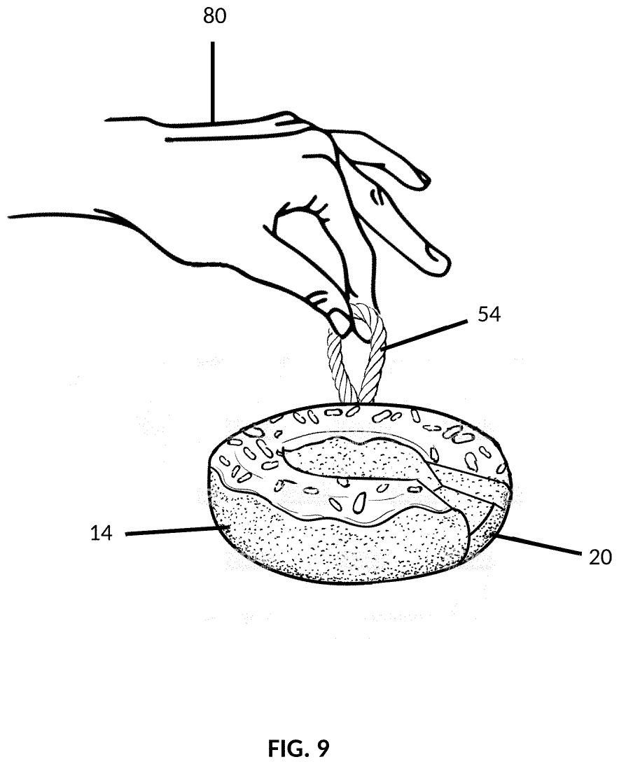

FIG. 9 shows how one can hold the tab/handle/loop 54 to move the device 14 from place to place without having to touch the body of the device 14, which includes a slot 20, or the ground where it is being placed. In this image, the user 80 is able to carry the device 14 by holding the handle/loop/tab 54 that in this example is made of rope positioned on the side and edge of device 14. The handle/tab/loop 54 may be placed anywhere on the wheel motion-restraining device 14, but generally would be placed where loop 54 would not be dirtied by touching the ground. Alternative embodiments of wheel motion-restraining devices may have one or more handles or none at all, or one or more holes that allow the user to choose what type of material to use for a handle and where to place the handle.

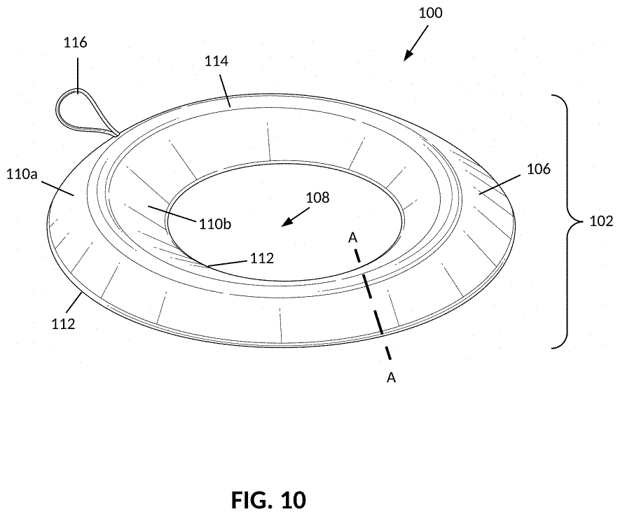

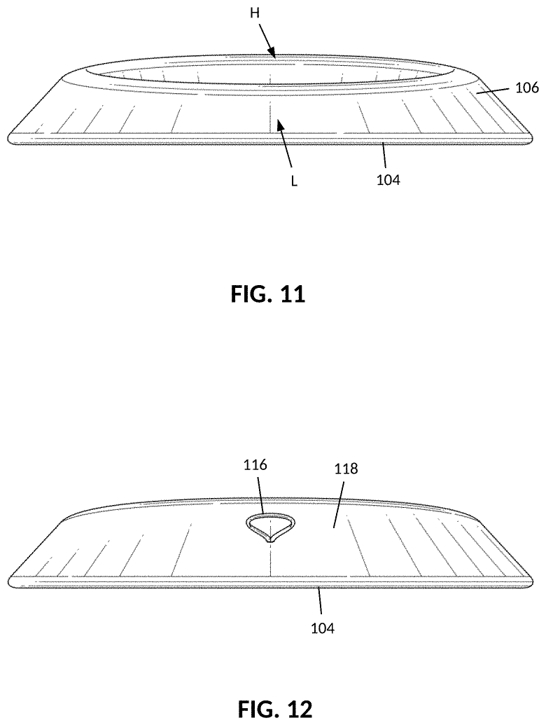

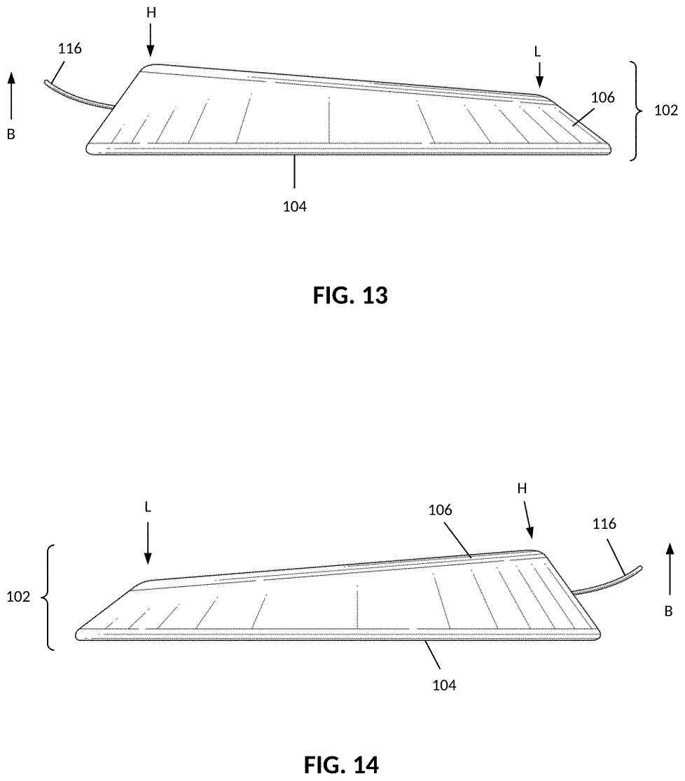

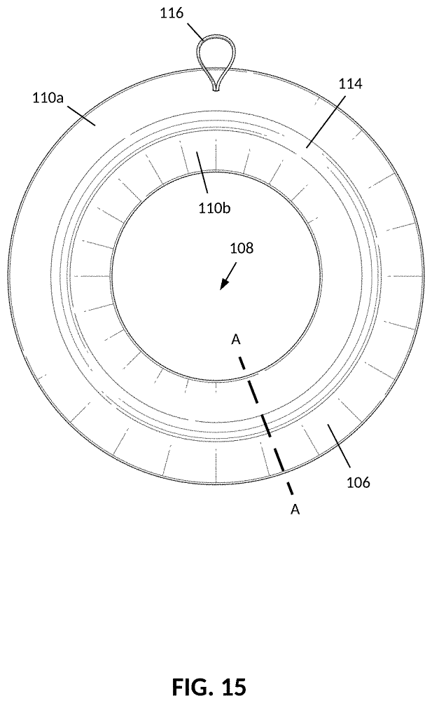

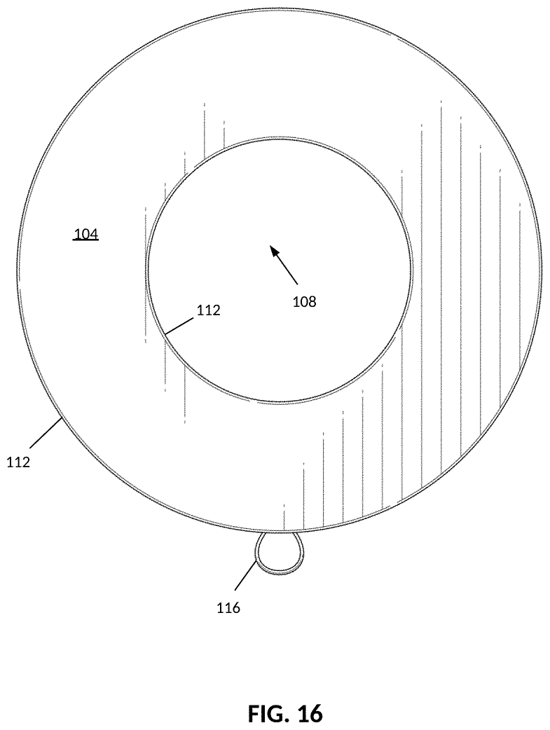

FIG. 10 is a top perspective view of a wheel motion-restraining device 100 having a body 102 with a substantially flat bottom surface 104, a raised top surface 106, and a central depression 108. As shown, raised top surface 106 is higher (H) on one side of central depression 108 than on the other side (L) of central depression 108, and raised top surface 104 is formed by two substantially planar surfaces 110a and 110b that meet between edges 112 of the substantially flat bottom surface 104 to form a peak 114. In the embodiment shown, body 102 is substantially circular with a substantially triangular cross section (A-A), and an open central depression 108. FIG. 11 is a front plan view of the device of FIG. 10. FIG. 12 is a back plan view of the device of FIG. 10. FIG. 13 is a right side view of the device of FIG. 10. FIG. 14 is a left side view of the device of FIG. 10. FIG. 15 is a top plan view of the device of FIG. 10. In FIGS. 12-15, a handle 116 is shown affixed to body 102. Particularly, handle 116 is affixed to an outer wall 118 of body 102, and handle 116 is biased away from the substantially flat bottom surface 104 (in the direction of arrow B). FIG. 16 is a bottom plan view of the device of FIG. 10. In an embodiment, one or more magnets (not shown) may be disposed on or within the substantially flat bottom surface 104.

### STATEMENTS REGARDING INCORPORATION BY REFERENCE AND VARIATIONS

All references cited throughout this application, for example patent documents including issued or granted patents or equivalents; patent application publications; and non-patent literature documents or other source material are hereby incorporated by reference herein in their entireties, as though individually incorporated by reference.

The terms and expressions which have been employed herein are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the invention has been specifically disclosed by preferred embodiments, exemplary embodiments and optional features, modification and variation of the concepts herein disclosed can be resorted to by those skilled in the art, and that such modifications and variations are considered to be within the scope of this invention as defined by the appended claims. The specific embodiments provided herein are examples of useful embodiments of the invention and it will be apparent to one skilled in the art that the invention can be carried out using a large number of variations of the devices, device components, and method steps set forth in the present description. As will be apparent to one of skill in the art, methods and devices useful for the present methods and devices can include a large number of optional composition and processing elements and steps.

When a group of substituents is disclosed herein, it is understood that all individual members of that group and all subgroups are disclosed separately. When a Markush group or other grouping is used herein, all individual members of the group and all combinations and subcombinations possible of the group are intended to be individually included in the disclosure.

It must be noted that as used herein and in the appended claims, the singular forms “a”, “an”, and “the” include plural reference unless the context clearly dictates otherwise. Thus, for example, reference to “a magnet” includes a plurality of such magnets and equivalents thereof known to those skilled in the art, and so forth. As well, the terms “a” (or “an”), “one or more” and “at least one” can be used interchangeably herein. It is also to be noted that the terms “comprising”, “including”, and “having” can be used interchangeably. The expression “of any of claims XX-YY” (wherein XX and YY refer to claim numbers) is intended to provide a multiple dependent claim in the alternative form, and in some embodiments is interchangeable with the expression “as in any one of claims XX-YY.”

Unless defined otherwise, all technical and scientific terms used herein have the same meanings as commonly understood by one of ordinary skill in the art to which this invention belongs. Although any methods and materials similar or equivalent to those described herein can be used in the practice or testing of the present invention, the preferred methods and materials are described. Nothing herein is to be construed as an admission that the invention is not entitled to antedate such disclosure by virtue of prior invention.

Whenever a range is given in the specification, for example, a range of integers, a temperature range, a time range, a composition range, or concentration range, all intermediate ranges and subranges, as well as all individual values included in the ranges given are intended to be included in the disclosure. As used herein, ranges specifically include the values provided as endpoint values of the range. As used herein, ranges specifically include all the integer values of the range. For example, a range of 1 to 100 specifically includes the end point values of 1 and 100. It will be understood that any subranges or individual values in a range or subrange that are included in the description herein can be excluded from the claims herein.

As used herein, “comprising” is synonymous and can be used interchangeably with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. In each instance herein any of the terms “comprising”, “consisting essentially of” and “consisting of” can be replaced with either of the other two terms. The invention illustratively described herein suitably can be practiced in the absence of any element or elements or limitation or limitations which is/are not specifically disclosed herein.

All art-known functional equivalents of materials and methods are intended to be included in this disclosure. The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the invention has been specifically disclosed by preferred embodiments and optional features, modification and variation of the concepts herein disclosed can be resorted to by those skilled in the art, and that such modifications and variations are considered to be within the scope of this invention as defined by the appended claims.

What is claimed is:

1. A motion-restraining device comprising:
a body having a substantially flat bottom surface, a raised top surface, and
a central depression,
wherein the raised top surface is higher on one side of the central depression than on the other side of the central depression.

2. The motion-restraining device of claim 1, wherein the raised top surface is formed by two substantially planar surfaces that meet between edges of the substantially flat bottom surface to form a peak.

3. The motion-restraining device of claim 1, wherein the body is substantially circular, substantially square, substantially triangular, substantially pentagonal or substantially hexagonal in shape.

4. The motion-restraining device of claim 1, wherein the body has a substantially triangular cross section, a substantially rectangular cross section or a substantially trapezoidal cross section.

5. The motion-restraining device of claim 1, wherein the body is a cylinder cut on the bias.

6. The motion-restraining device of claim 1, wherein the central depression is open or partially filled with material of the body or completely filled with material of the body.

7. The motion-restraining device of claim 1, wherein the motion-restraining device is formed of a material selected from the group consisting of plastic, rubber, silicone, wood, metal, carbon fiber, rope, wire and combinations thereof.

8. The motion-restraining device of claim 1, wherein an outer diameter of the body is between 3 inches and 12 inches.

9. The motion-restraining device of claim 1, wherein an inner diameter of the body is between 1 inch and 10 inches.

10. The motion-restraining device of claim 1, wherein a height of the body is between 0.5 inches and 3 inches.

11. The motion-restraining device of claim 1 further comprising one or more magnets on or within the substantially flat bottom surface.

12. The motion-restraining device of claim 1, further comprising a handle affixed to the body.

13. The motion-restraining device of claim 12, wherein the handle is affixed to an outer wall of the body.

14. The motion-restraining device of claim 12, wherein the handle is biased away from the substantially flat bottom surface.

15. The motion-restraining device of claim 1, further comprising a slot within the body.

16. The motion-restraining device of claim 15, wherein the slot extends completely or partially through a height of the body.

17. The motion-restraining device of claim 1, wherein the substantially flat bottom surface and/or the raised top surface is textured.

18. A method of using a motion-restraining device comprising:
providing the motion-restraining device of claim 1; and
positioning a wheel within the central depression.

19. The method of claim 18, wherein the step of positioning the wheel comprises rolling the wheel through a slot within a wall of the body.

20. The method of claim 18, wherein the step of providing comprises removing the motion-restraining device from a magnetic surface.
